(19) United States
(12) Patent Application Publication
(10) Pub. No.: US 2011/0274892 A1
(43) Pub. Date: Nov. 10, 2011

(54) BIAXIALLY ORIENTED BIO-BASED POLYOLEFIN FILMS AND LAMINATES

(75) Inventors: Keunsuk P. Chang, North Kingstown, RI (US); Michael F. Brandmeier, Narragansett, RI (US)

(73) Assignee: TORAY PLASTICS (AMERICA), INC., N. Kingstown, RI (US)

(21) Appl. No.: 13/102,415

(22) Filed: May 6, 2011

Related U.S. Application Data
(60) Provisional application No. 61/332,380, filed on May 7, 2010.

(51) Int. Cl. B32B 27/32; C08K 3/04; B29C 47/14; B32B 3/10

(52) U.S. Cl. 428/195.1; 428/515; 428/519; 428/461; 428/500; 428/521; 264/5; 156/244.11; 156/244.16

(57) ABSTRACT

A laminate film including at least one bio-based polyolefin layer including at least 53 pMC of radiocarbon (¹⁴C) content is disclosed. The laminate film may include additional layers such as a second bio-based polyolefin resin-containing layer of at least 53 pMC radiocarbon content, and a metal layer.

### CROSS-REFERENCE TO RELATED APPLICATION

This Application claims the benefit of U.S. Provisional Application 61/332,380 filed on May 7, 2010, the entire contents of which is incorporated herein by reference.

### FIELD OF THE INVENTION

This invention relates to a biaxially oriented film including a bio-based polyolefin which is derived from non-petroleum-sourced monomers. This invention also relates to multi-layer biaxially oriented polypropylene and polyethylene films and laminates of same, which are made from novel bio-based propylene, ethylene, and butene homopolymers and copolymers. Such films exhibit excellent properties, including gas barrier properties particularly after metallizing, substantially equivalent to their petroleum-based counterparts, while being derived from non-petroleum sources.

### BACKGROUND OF THE INVENTION

Biaxially oriented polyolefin films are used for packaging, decorative, and label applications and often perform multiple functions. In particular, biaxially oriented polypropylene (BOPP) and biaxially oriented polyethylene (BOPE) films and laminations are popular, high performing, and cost-effective flexible substrates for a variety of snack food packaging applications. In a lamination, they provide printability, transparent or matte appearance, or slip properties. The films sometimes provide a surface suitable for receiving organic or inorganic coatings for gas and moisture barrier properties. The films sometimes provide a heat sealable layer for bag forming and sealing, or a layer that is suitable for receiving an adhesive either by coating or by laminating.

In recent years, interest in “green” packaging has been strongly developing. Packaging materials based on biologically derived polymers are increasing due to concerns with non-renewable resources, raw materials, and greenhouse gas generation. Bio-based polymers are believed—once fully scaled-up—to reduce reliance on petroleum, reduced production of greenhouse gases, and are derived from renewable or sustainable sources such as plants. Bio-based polymers such as polylactic acid (PLA)—which is currently derived from corn starch—are one of the more popular and commercially available materials that can be used for packaging film applications.

For such a bio-based polymer to be fit-for-use for many snack food packaging applications, it is desirable that the bio-based polymer film match as many of the attributes possible that BOPP is well-known for, such as heat sealability, printability, controlled COF, metallizability, barrier, etc. In particular, for high barrier packaging, metallized bio-based oriented films should demonstrate good oxygen and moisture barrier properties. For example, in the case of a metallized oriented PLA, good oxygen barrier property is generally easily achieved due to the polar nature of PLA, which provides good hydrogen-bonding of the polymer molecules. However, this polar nature tends to be detrimental for achieving high moisture barrier. Without being bound by any theory, the thought is that water molecules—being polar themselves—may more easily migrate through a polar polymer film than a non-polar polymer film. In addition, it is possible that the PLA substrate can absorb moisture and swell, thus changing the physical and dimensional properties of the PLA substrate. In particular, such swelling—especially at the interface between the vapor-deposited metal in a metallized PLA film and the adjacent PLA substrate surface—can cause morphological and dimensional changes in which the relatively inflexible inorganic metal layer can not conform to. This can then result in cracking of the metal layer and attendant loss of gas barrier properties.

There are other issues inherent with using bio-polymers such as PLA in flexible packaging applications. The sequential orientation film-making productivity of biaxially oriented PLA film (BOPLA), for example, cannot match that of BOPP due to limitations in processing speed (i.e. machine direction stretch ratio is typically lower than BOPP) and production film width (i.e. transverse direction stretching is typically less than BOPP). BOPLA typically has lower thermal resistance and higher heat shrinkage than BOPP which can be a problem in downstream processes seen in converting such as drying temperatures after printing or coating, extrusion lamination, and metallizing. In addition, from an end-user stand-point, the high stiffness of BOPLA packaging can make it prone to dead-fold issues whereby the package can be easily creased, causing a shelf-worn appearance; and furthermore, the BOPLA package can be much noisier than a BOPP package which can a consumer complaint.

However, if BOPP packaging could be made from bio-based sources instead of petroleum sources, this would help solve the converting, end-user concerns, and consumer concerns that BOPLA packaging entails, while reducing reliance on petroleum, reducing overall potential carbon footprint, and being produced from a sustainable resource (plants). The only drawback would be that unlike BOPLA or some other bio-polymers, BOPP is not be compostable or degradable without modifying additives. However, without being bound by any theory, a bio-based/sourced BOPP could be a way to sequester carbon dioxide from the atmosphere as the source plant material could take in CO₂ from the atmosphere which is then converted to polyolefins such as polypropylene and polyethylene and then converted to polyolefin packaging which does not degrade and return CO₂ to the atmosphere.

Bio-based polypropylene or other polyolefins differ from conventional petroleum-based polypropylene or polyolefins in that ¹⁴C-isotope measurements show that the quantity of ¹⁴C in bio-sourced materials is significantly higher than in petroleum-based materials due to the continual uptake of this isotope by living plants and organisms. In petroleum-derived polypropylene, however, ¹⁴C-isotope is essentially undetected using ASTM International standards (ASTM D6866). This is due to the half-life of ¹⁴C (about 5730±40 years) and the decay of this isotope over the hundreds of millions of years since the original organisms existed, took up said ¹⁴C, and turned into petroleum. Thus, bio-based or bio-sourced polyolefins may be characterized by the amount of ¹⁴C they contain. The decay of ¹⁴C isotope is famously known for radiocarbon-dating of archeological, geological, and hydrogeological artifacts and samples and is based on its activity of about 14 disintegrations per minute (dpm) per gram carbon.

Coca-Cola Company's US patent application publication 20090246430A1 states that “It is known in the art that carbon-14 (C-14), which has a half life of about 5,700 years, is found in bio-based materials but not in fossil fuels. Thus, “bio-based materials” refer to organic materials in which the carbon comes from non-fossil biological sources. Examples of bio-based materials include, but are not limited to, sugars, starches, corns, natural fibers, sugarcanes, beets, citrus fruits, woody plants, cellulosics, lignocelluosics, hemicelluloses, potatoes, plant oils, other polysaccharides such as pectin, chitin, levan, and pullulan, and a combination thereof . . . As explained previously, the detection of C-14 is indicative of a bio-based material. C-14 levels can be determined by measuring its decay process (disintegrations per minute per gram carbon or dpm/gC) through liquid scintillation counting. In one embodiment of the present invention, the bio-based PET polymer includes at least about 0.1 dpm/gC (disintegrations per minute per gram carbon) of C-14.” This is a useful definition of bio-based materials to distinguish them from their traditional petroleum-based counterparts. This reference teaches the use of bio-based ethylene glycols and terephthalic acids to form a bio-based polyethylene terephthalate resin useful for beverage bottles.

TAPPI presentation Apr. 18-21, 2010 Conference “Green Polyethylene: Bringing Renewable Raw Materials to the Traditional Plastic Industry” by Braskem S. A. describes the production of polyethylenes using feedstocks of ethylene monomer made from plant sugars instead of petroleum-based feedstocks. The polyethylene made from plant sugars is chemically equivalent to traditional polyethylene made from petroleum. The presentation also describes initial laboratory work to produce polypropylene made from plant sugars. The plant-based origin of such polyethylenes and polypropylenes can be verified via ¹⁴C dating due to the uptake of ¹⁴C from the atmosphere during the plant's life. The plant sugars (e.g. from sugar cane, corn, sugar beet) are converted to ethanol which is then converted to the appropriate monomer. The monomer is then polymerized to the desired polyolefin homopolymer or copolymer. In such a process, no petroleum-based feedstocks or monomers are used.

US Patent Publication No. 20100028512A1 describes a method to produce bio-based polyester terephthalate (PET) resin which may then be used to make articles, containers, or packaging for food and beverage products. The application also discloses the use of bio-based polyethylene to produce closures, caps, or lids for bio-based PET containers as well as the use of bio-based polyethylene labels via film extrusion for said containers. However, there is no contemplation of producing bio-based polyolefin films for packaging applications.

### SUMMARY OF THE INVENTION

Described are films and methods for producing useful films and laminations using bio-based propylene, ethylene, and butene homopolymers and copolymers. These films may be used for various packaging applications. Such bio-based polyolefin articles will contain a certain amount of ¹⁴C-isotope, a quantity that is thus distinguishable from petroleum-based polyolefins. These bio-based polyolefins are made from, in turn, bio-based monomers, which are derived from plant-based intermediates such as alcohols and sugars. The above issues of making high gas and moisture barrier metallized BOPP and BOPE films and laminations from bio-based polypropylenes, polyethylenes, polybutenes, and copolymers and terpolymers of said bio-based polyolefin resins and monomers are addressed. The inventors have found solutions whereby the use of such materials in packaging applications can maintain current levels of quality, processability, and capital assets while reducing net carbon dioxide emissions.

One embodiment is a laminate film including a first bio-based polyolefin resin-containing layer B, said bio-based polyolefin selected from the group of polypropylene, polyethylene, polybutene, polystyrene, polycyclic olefin, polyolefin copolymers, or blends thereof. Preferable bio-based polyolefins include polyethylene, high density polyethylene, low density polyethylene, linear low density polyethylene, medium density polyethylene, crystalline polypropylene, high crystalline polypropylene, mini-random polypropylene, ethylene-propylene copolymers, ethylene-butene copolymers, ethylene-propylene-butene copolymers, propylene-butene copolymers, or blends thereof. This first bio-based polyolefin resin-containing layer B could be considered a base or core layer.

The amount of bio-based content of the polyolefin can be determined using test procedure ASTM D6866 which measures the amount of ¹⁴C isotope (also known as “radiocarbon”) in said polyolefin and compares it to a modern reference standard. This ratio of measured ¹⁴C to the standard can be reported as “percent modern carbon” (pMC). Petroleum or fossil fuel-based polyolefin will have essentially 0% radiocarbon (0 pMC) whereas contemporary bio-based or bio-mass polyolefin should have about or near 100% radiocarbon (107.5 pMC). It is preferable that the ratio of biomass-based polyolefin to petroleum-based polyolefin in layer B be at least 53 pMC, and more preferably at least 97 pMC, and even more preferably, about 107.5 pMC.

In a further embodiment, the laminate could include a second polyolefin resin-containing layer A contiguously attached upon one side of the first bio-based polyolefin resin-containing layer B. This second polyolefin resin-containing layer A could be either a petroleum-based polyolefin or a bio-based polyolefin like the first layer B. Preferably, this second layer A is also a bio-based polyolefin resin-containing layer of at least 53 pMC, more preferably at least 97 pMC, and even more preferably, about 107.5 pMC. Furthermore, the laminate could further embody a third polyolefin resin-containing layer C contiguously attached on the side of the first bio-based polyolefin resin-containing core layer B, opposite the second polyolefin resin-containing A. Preferably, as with the second polyolefin layer A, the third polyolefin resin-containing layer C is also comprised of a bio-based polyolefin of at least 53 pMC, and more preferably at least 97 pMC, and even more preferably, about 107.5 pMC. Other embodiments could include additional intermediate layers between the layers A and B and between the layers B and C. Such intermediate layers of the multi-layer structure may be symmetrically or asymmetrically disposed around the bio-based polyolefin core layer B. Preferably, such intermediate layers are also comprised of bio-based polyolefins for the purpose of ensuring as high a content of bio-sourced sustainable materials in the overall multi-layer laminate film structure. Preferably, said intermediate layers should be at least 53 pMC and more preferably at least 97 pMC, and even more preferably, about 107.5 pMC.

Preferably, the second bio-based polyolefin resin-containing layer A includes a formulation suitable for receiving a metal layer via vapor deposition by processes known in the art, preferably including aluminum with a thickness of about 5-100 nm and an optical density of about 1.5-5.0. Additionally, this layer can also be suitably formulated for receiving printing inks or coatings as desired. Layer A is preferably a bio-based polyolefin selected from, but not limited to, propylene homopolymer, propylene copolymers with ethylene and/or butene, ethylene homopolymer (particularly, high density polyethylene), and blends thereof to achieve good metal adhesion or printing ink adhesion. Preferably, the outer surface of layer A (the surface opposite the side in contiguous contact with layer B) is discharge-treated (e.g. corona discharge treatment, flame treatment, controlled atmosphere corona treatment, atmospheric plasma treatment) so as to raise the surface energy/wetting tension of said surface to make it more receptive for metal deposition or ink adherence. In addition, an amount of antiblock may be incorporated into the bio-based polyolefin layer A including an antiblock component selected from the group including, but not limited to, amorphous silica, aluminosilicate, sodium calcium aluminum silicate, crosslinked silicone polymer, polymethylmethacrylate, and/or blends thereof.

Preferably, the third bio-based polyolefin resin-containing layer C includes a heat-sealable polyolefin selected from the group including, but not limited to, propylene copolymers, terpolymers, polyethylene, and/or combinations thereof. This preferably bio-based heat-sealable layer C also includes an antiblock component selected from the group including, but not limited to, amorphous silica, aluminosilicate, sodium calcium aluminum silicate, crosslinked silicone polymer, polymethylmethacrylate, and/or blends thereof.

Alternatively, the third bio-based polyolefin resin-containing layer C could also include a non-heat-sealable winding layer including a bio-based crystalline polypropylene and an inorganic antiblocking agent for controlling the coefficient of friction (COF). This non-heat-sealable winding layer can include a crystalline propylene homopolymer with an antiblock component selected from, but not limited to, amorphous silicas, aluminosilicates, sodium calcium aluminum silicate, a crosslinked silicone polymer, and polymethylmethacrylate. Preferably, the crystalline propylene homopolymer is made from bio-sourced propylene monomers. The third bio-based polyolefin resin-containing layer C could also be a winding layer including a matte resin layer of a block copolymer blend of propylene and one or more other monomers such as ethylene, the matte layer having a roughened surface. The matte layer polymer components of ethylene and propylene are preferably made from bio-sourced monomers. In both embodiments, the winding layer is also a discharge-treated winding layer having a surface for lamination or coating with adhesives or inks.

Another embodiment is a method for forming flexible packaging including obtaining a laminate film including a bio-based polyolefin resin-containing layer and surrounding a product by the laminate film. Preferably, the product is a food product.

In yet another embodiment, this invention provides biaxially oriented bio-based polyolefin multi-layer films for flexible packaging purposes. Another embodiment provides a metallized biaxially oriented bio-based polyolefin multi-layer barrier films. An additional embodiment provides laminate structures of bio-based polyolefin layers and metallized layers for barrier applications in flexible packaging.

Yet another embodiment is a laminate bio-based polyolefin film including a bio-based polyolefin resin-containing layer having a radiocarbon content of at least 53 pMC. The bio-based polyolefin film may be biaxially oriented and may include a crystalline isotactic propylene homopolymer. The bio-based polyolefin resin-containing layer may be co-extruded with one or more additional layers including bio-based polyolefins. The additional layers may include, for example, a bio-based propylene homopolymer, ethylene homopolymer, propylene-ethylene copolymer, propylene-ethylene-butene copolymer, or ethylene-butene copolymer. The bio-based polyolefin resin-containing layer preferably includes a polyolefin derived from a plant sugar. The bio-based polyolefin resin-containing layer preferably includes a bio-based ethylene homopolymer, more preferably a high density ethylene homopolymer.

The laminate bio-based polyolefin film may be discharge-treated and then a metal layer may be applied to the discharge-treated surface. A preferred metal layer is an aluminum metal layer. The metal layer preferably has an optical density of 1.5-5.0.

Another embodiment is a lamination including a first biaxially oriented bio-based polyolefin film having a radiocarbon content of at least 53 pMC, a second biaxially oriented bio-based polyolefin film having a radiocarbon content of at least 53 pMC, and an adhesive that laminates the first biaxially oriented bio-based polyolefin film to the second biaxially oriented bio-based polyolefin film.

A vapor-deposited aluminum layer is preferably deposited on a side of the first biaxially oriented bio-based polyolefin film. Inks exhibiting a graphic content may be applied to a side of the second biaxially oriented bio-based polyolefin film. The first biaxially oriented bio-based polyolefin film and the second biaxially oriented bio-based polyolefin film may include, for example, propylene homopolymer or ethylene homopolymer of at least 53 pMC. The adhesive may include a bio-based low density polyethylene of at least 53 pMC.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### DETAILED DESCRIPTION OF THE INVENTION

Described are biaxially oriented films including a bio-based polyolefin that is derived from non-petroleum-sourced monomers. Also described are multi-layer biaxially oriented polypropylene and polyethylene films and laminates of same, which are made from novel bio-based propylene, ethylene, and butene homopolymers and copolymers. Such films exhibit excellent properties, including gas barrier properties particularly after metallizing, substantially equivalent to their petroleum-based counterparts, while being derived from non-petroleum sources.

In one embodiment, the biaxially oriented polyolefin film includes at least 53 pMC-containing bio-based polyolefin or about 49% biomass content. The film includes at least a single layer B as a base or core layer. The content or percentage of the film of bio-based origin is determined by comparing the amount of radiocarbon (¹⁴C isotope) to a modern reference sample. Radiocarbon (also known as “carbon 14”, “C-14”, or “¹⁴C”) is a weakly radioactive, naturally occurring element in all living organisms. ¹⁴C is taken up continuously by the organism (plant or animal) over its lifetime; when the organism dies (or is harvested such as sugar cane or corn or other crops), this ¹⁴C uptake ceases. Thus, contemporary biomass or materials and articles made from such biomass has a significant amount of radiocarbon, typically about 100% radiocarbon. In comparison, fossil fuels such as coal and petroleum oil have typically about 0% radiocarbon. This is because fossil fuels and petroleum were formed hundreds of millions of years in the past from buried plants and algae to form coal and petroleum deposits. The algae and plants from that time period ceased uptake of ¹⁴C and as ¹⁴C has a half-life of about 5730 years, over those 300 million years or so since the original algae and plants died and turned into fossil fuels, the ¹⁴C isotope in them decayed to the point where such fossil fuels essentially contain zero radiocarbon. By comparing the amount of ¹⁴C in a bio-based polyolefin film to a “modern reference standard,” this ratio can be representative of a percent biomass content of the film with the units “pMC” (percent modern carbon).

The “modern reference standard” used in radiocarbon dating is a NIST (National Institute of Standards and Technology) standard with a known radiocarbon content equivalent to about the year 1950 AD. The year 1950 was chosen since it was the year that calibration curves for radiocarbon dating were established and also was a useful marker year prior to large-scale thermo-nuclear weapons testing which altered the global ratio of ¹⁴C to ¹²C. This standard represents 100 pMC. Present day (post-1950 AD) articles made from contemporary biomass sources typically show pMC greater than 100 due to the increase of ¹⁴C due to nuclear weapons testing (also known as “bomb carbon”). At the time of this writing, contemporary biomass-sourced articles have about 107.5 pMC. Thus, bio-based polyolefins made recently from sugar cane or corn starches (which were subsequently fermented to ethanol or methanol and converted to ethylene, propylene or other monomers) would show a pMC of about 107.5. Fossil fuel/petroleum-based articles or polyolefins would have a pMC of about 0.Thus, conventionally, it has been useful and convenient to assign a value of “100% biomass content” to articles that exhibit about or near 107.5 pMC and “0% biomass content” to articles that exhibit about or near 0 pMC. In this way, one can calculate and assign percent biomass content to articles that include both bio-based carbon and fossil fuel-based carbon. For example, a polyolefin film containing a mixture of 50 wt % bio-sourced polyolefin and 50 wt % petroleum-sourced polyolefin would exhibit a pMC of about 54. This would equate to about “50% biomass content” for said film (Reference material from Beta Analytic Inc. website www.betalabservices.com “Explanation of Results—Biobased Analysis using ASTM D6866”).

In one set of embodiments, the bio-based film layer B is a crystalline polypropylene of specific isotactic content and can be uniaxially or biaxially oriented. Crystalline polypropylenes are generally described as having an isotactic content of about 90% or greater as measured by ¹³C NMR isotactic index. These resins have melt flow rates of about 0.5 to 5 g/10 min, a melting point of about 163-167° C., a crystallization temperature of about 108-126° C., a heat of fusion of about 86-110 J/g, a heat of crystallization of about 105-111 J/g, and a density of about 0.90-0.91. The pMC value of these crystalline polypropylenes is preferably at least 53 and more preferably about 107.5. The bio-based resin layer B is typically 5 μm to 50 μm in thickness after biaxial orientation, preferably between 10 μm and 25 μm, and more preferably between 12.5 μm and 17.5 μm in thickness. Additionally, a small amount of inorganic antiblocking agent may be optionally added up to 1000 ppm to this resin layer. Preferably 300-500 ppm of antiblock may be added. Suitable antiblock agents include those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 μm, preferably in the range of 2-6 μm.

The bio-based crystalline polypropylene resin can be polymerized from plant-sourced propylene monomer. One process or method to produce such plant-sourced monomer is to ferment sugar cane or other plant sugars and starches and distill into ethanol (CH3—CH2—OH). Through a dehydration process using mineral acids, strong organic acids, suitable catalysts and combinations thereof, the ethanol can be converted to ethylene monomer (CH2═CH2), which in turn can be dimerized into butene monomer (CH3—CH═CH—CH3). With additional stoichiometric ratio of ethylene, the butene and ethylene monomers can be catalytically converted via olefin metathesis into propylene monomer (CH3—CH═CH2). Olefin metathesis is typically a cycloaddition reaction between a transition metal alkylidene complex and the olefin to form an intermediate metallacyclobutane. This metallacyclobutane then breaks up in the opposite fashion to afford a new alkylidene and new olefin. This process is repeated until an equilibrium mixture of olefins is obtained.

In this way, bio-based monomers of ethylene, propylene, and butene can each be produced, each exhibiting a high pMC (e.g. 107.5) since these monomers are produced directly from contemporary plant materials. The said monomers are chemically identical (barring the ¹⁴C isotope content) to the same monomers made from petroleum via cracking processes well known in the art. Thus, these bio-sourced monomers can be polymerized either as their respective homopolymers (e.g. ethylene homopolymer, propylene homopolymer, or butene homopolymer) or as copolymers (e.g. ethylene-propylene copolymer, ethylene-butene copolymer, propylene-butene copolymer, ethylenene-propylene-butene copolymer (aka “terpolymer”)) wherein the amounts of each individual monomer content of the copolymer can be varied as desired. In addition, such bio-based copolymers may be random or block copolymers. The polymerization of said bio-based monomers can be carried out in conventional catalytic processes well known in the art using Ziegler-Natta catalysts or metallocene catalysts, including but not exclusively, such processes as Spheripol®, Unipol®, gas-phase, and/or slurry processes for polyolefin polymerization. Such bio-based polyolefins as polyetheylene or polypropylene may be obtained in a limited availability from Braskem S. A. It can also be contemplated to use a mixture of bio-based monomers and petroleum or fossil fuel-based monomers to make a polyolefin including both types of monomers. Such a polyolefin would have a varying amount of biomass content as desired by the mixture chosen. Preferably, such a “mixed” parentage polyolefin would be at least 49% biomass content, exhibiting at least 53 pMC.

Useful bio-based copolymers such as ethylene-propylene copolymer have a nominal ethylene content from about 0.1-20 wt % of the polymer, preferably 4.0-8.0 wt % ethylene; nominal melt flow rate at 230° C. of 1.0-20.0 g/10 min, preferably 4.0-10.0 g/10 min; nominal melting point of 100-150° C., preferably 135-145° C.; and density of 0.80-0.90, preferably 0.85-0.90. Useful terpolymers of ethylene, propylene and butene have a nominal ethylene content of about 0.10-10 wt % of the polymer, preferably 1.5-5.0 wt %; nominal butene content of about 0.10-30 wt %, preferably 2.0-18.0 wt %; nominal melting point of 60-120° C., preferably 80-100° C.; and nominal density of about 0.80-0.90.

Other embodiments can include multi-layer films in which each respective layer includes a bio-based polyolefin of at least 53 pMC. For example, the layer B including a bio-based polypropylene can have a contiguous skin layer A coextruded upon one side of layer B. If desired, a second skin layer C can be coextruded upon the side of layer B opposite the side in contact with layer A. It can be contemplated to interpose additional intermediate layers between the layers A and B and between B and C, in either symmetric or asymmetric structures. Preferably, all these additional layers—A, C, and intermediate layers—includes bio-based polyolefin of at least 53 pMC.

These skin layers A and C can be coextruded on the respective sides of the core layer B, each skin layer having a thickness after biaxial orientation between 0.1 and 10 μm, preferably between 0.5 and 5 μm, and more preferably between 0.5 and 2.0 μm. In a further embodiment in which the layer A's outer surface is used for receiving a vapor-deposited metal (and/or metal oxides or silicone oxides) or for receiving printing inks or coatings (for adhesives, gas barrier materials, solvent or aqueous) it is also contemplated to add an antiblock to aid in film handling. A small amount of inorganic antiblocking agent may be optionally added up to 1000 ppm to this resin layer. Preferably 300-500 ppm of antiblock may be added. Suitable antiblock agents include those such as inorganic silicas, sodium calcium aluminosilicates, crosslinked silicone polymers such as polymethylsilsesquioxane, and polymethylmethacrylate spheres. Typical useful particle sizes of these antiblocks range from 1-12 μm, preferably in the range of 2-6 μm.

The bio-based layer A can be optionally surface-treated with either a corona-discharge method, flame treatment, atmospheric plasma, or corona discharge in a controlled atmosphere of nitrogen, carbon dioxide, or a mixture thereof, to improve wetting tension for the improved receptivity of said vapor-deposited metal, inks, or coatings. The latter treatment method in a mixture of CO₂ and N₂ (to the exclusion of O₂) is particularly preferred. This method of discharge treatment results in a treated surface that includes nitrogen-bearing functional groups, preferably 0.3% or more nitrogen in atomic %, and more preferably 0.5% or more nitrogen in atomic %. A wetting tension of at least 36 dyne-cm/cm² is preferred, and more preferably, a wetting tension of 39-41 dyne-cm/cm². This treated layer can then be metallized, printed, coated, or extrusion or adhesive laminated.

Additionally, in the embodiment of only a single bio-based polyolefin layer B, one or both surfaces of layer B may be discharge-treated for similar purposes as described above.

The bio-based layer C can be a heat-sealable layer or non-heat sealable layer contiguously coextruded with the core layer B opposite the layer A. As a heat-sealable layer, layer A may contain an anti-blocking agent and/or slip additives for good machinability and a low coefficient of friction in an amount of about 0.05-0.5% by weight of the heat-sealable layer. The heat-sealable layer will be preferably a bio-based copolymer of propylene, either ethylene-propylene or butene-propylene, and preferably include a ternary ethylene-propylene-butene copolymer, and further preferably, including at least 53 pMC. In the embodiment in which layer C includes a non-heat sealable, winding layer, this layer will include a crystalline polypropylene with anti-blocking and/or slip additives or a matte layer of a block copolymer blend of polypropylene and one or more other polymers, or a blend of propylene-based polymer and ethylene homopolymer, whose surface is roughened during the film formation step so as to produce a matte finish on the winding layer. Preferably, the surface of said non-heat sealable winding layer is discharge-treated to provide a functional surface for lamination or coating with adhesives and/or inks. Preferably, said winding layer includes at least 53 pMC bio-based polyolefins.

In addition to inorganic antiblocks being added to each respective layer of the above set of embodiments, it can be contemplated to also add organic slip additives to reduce further coefficient of friction (COF) for the surfaces and layers of interest. Such slip additives can include, but are not limited to, fatty amides such as erucamide, stearamide, oleamide, behanamide, as well as silicone oils, waxes, silicone gels, and ultra high molecular weight silicone oils, and combinations of any of the above. It can also be contemplated to add anti-static additives such as glycerol monostearates and tertiary amines. However, for the purposes of producing high gas barrier metallized bio-based polyolefin films, it is desired that such migratory low molecular weight slip agents be avoided as they can cause poor barrier properties or poor metal adhesion. It can be contemplated to add hydrocarbon resins to the core layer B to enhance tensile properties or moisture barrier properties as well.

In other embodiments, the bio-based polyolefin film layer B includes polyethylene and preferably, high density polyethylene (HDPE), including at least 53 pMC, and more preferably about or near 107.5 pMC. Similar to the previous set of embodiments, the bio-based polyolefin film layer B may be mono-axially oriented or biaxially oriented, and may include multiple layers coextruded with layer B. A skin layer C may be contiguously coextruded with layer B wherein layer C includes a bio-based low density polyethylene (LDPE) or linear low density polyethylene (LLDPE) or blends thereof, of preferably at least 53 pMC and more preferably, about or near 107.5 pMC. Layer C can function as a heat sealable layer for a multi-layer laminate of B and C layers. In addition, a layer A can be coextruded contiguously upon the side of layer B opposite the side with layer C. Layer A can include a bio-based HDPE, MDPE, LDPE, LLDPE, or blends thereof for the purposes of a metal receiving layer or ink or coating receiving layer. It can also be contemplated to discharge-treat the outer surface of layer A (or layer B in the case of a single layer or two-layer structure) to enhance its receptivity for said metallizing or ink or coating adhesion. An amount of inorganic antiblock or slip agents as described previously can be added to the respective layers of interest to control COF properties.

Braskem S. A. manufactures a series of bio-based HDPE and LLDPE of at least 96% and 84% biomass content, respectively. A suitable film grade of bio-based HDPE is grade SGM9450F with melt flow index of nominal 0.33 g/10 min at 190° C./5 kg weight and density of 0.952. A suitable grade that can function as a heat seal layer coextruded with the HDPE B-layer is grade SLL118 series or SLL218 series with melt flow indexes of nominal 1.0-2.3 g/10 min at 190° C./2.16 kg weight and densities of 0.916-0.918. Bio-based LDPE that can be suitable for a heat seal layer can have a density of about 0.80-0.90, preferably about 0.88; nominal melt flow index at 190° C. of 0.5-20 g/10 min, preferably 8-10 g/10 min.

For the embodiments in which the biaxially oriented multilayer bio-based polyolefin is propylene-based, the coextrusion process includes a three-or four-layered compositing die. The bio-based polyolefin core layer B is sandwiched between the skin layer A and the heat sealable layer C. The multilayer laminate sheet is cast onto a cooling drum whose surface temperature is controlled between 20° C. and 60° C. to solidify the non-oriented laminate sheet. The non-oriented laminate sheet can be stretched via simultaneous or sequential orientation processes well-known in the art. In the latter case, the cast non-oriented laminate sheet is stretched first in the longitudinal or machine direction (MD) at about 135 to 165° C. at a stretching ratio of about 4 to about 5 times the original length and the resulting stretched sheet is cooled to about 15° C. to 50° C. to obtain a uniaxially oriented laminate sheet. The uniaxially oriented laminate sheet is introduced into a tenter and preliminarily heated between 130° C. and 180° C., and stretched in the transverse direction (TD) at a stretching ratio of about 7 to about 12 times the original length and then heat-set or annealed to reduce internal stresses due to the orientation and minimize shrinkage (typically about 8% shrinkage in the MD and 5% in the TD at 140° C. for 15 minutes) and give a relatively stable biaxially oriented sheet. The biaxially oriented film has a total thickness between 6 and 40 μm, preferably between 10 and 20 μm, and most preferably between 12 and 18 μm.

A preferred embodiment is to metallize the discharge-treated surface of the bio-based laminate film to improve gas barrier properties such as oxygen and moisture vapor. The unmetallized laminate sheet is first wound in a roll. The roll is placed in a metallizing vacuum chamber and the metal vapor-deposited on the discharge-treated bio-based polymer resin layer surface by high speed vapor deposition metallizing processes well known in the art. The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer shall have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metallized film is then tested for oxygen and moisture permeability, optical density, and metal adhesion. Preferred gas barrier values are in the range of 5-50 cc/m²/day oxygen transmission rate at 23° C. and 0% RH, and more preferably less than 31 cc/m²/day or less. Preferred moisture barrier values are in the range of 0.03-0.70 g/m²/day water vapor transmission rate at 38° C. and 90% RH, and more preferably less than 0.31 g/m²/day.

Thus, basic bio-based polyolefin film designs can be envisioned for different purposes such as metallizing, printing, coating etc. and these various films may also be combined together in laminations to provide suitable packaging films.

In a further set of embodiments, it is contemplated that a bio-based BOPP film designed as a transparent print film for receiving printing inks as described above may be laminated to a metallized bio-based BOPP film designed as a heat sealable metallizing basefilm as described above. The laminating adhesive may be solvent-borne, aqueous-borne, solventless, or extrusion types. If extrusion, a particularly preferred extrudate would be a bio-based low density polyethylene of at least 53 pMC and preferably about or near 107.5 pMC so as to maximize overall biomass content of the lamination structure. The preferred configuration for such a laminate would be: 1) a bio-based print OPP film reverse-printed with ink; 2) an aluminum metallized bio-based heat sealable OPP film with the aluminum metal deposited upon the side of the film opposite the heat sealable layer; 3) the two bio-based OPP films are then adhered to each other using molten bio-based low density polyethylene with the reverse-printed side of the bio-based print OPP film adhered to the aluminum metallized side of the bio-based metallized OPP film. Other bio-based OPP film designs can be contemplated and lamination structures envisioned. Such bio-based laminations may include more than 2 films laminated together; also contemplated is a mono-layer or single bio-based OPP film used for various purposes. A preferred purpose for such contemplated laminations is for flexible packaging, in particular for snack food packaging.

Similar to the above-described method to produce bio-based BOPP films and laminates, similar films can be produced using bio-based polyethylene to produce bio-based BOPE films and laminates or combinations of bio-based BOPP and BOPE in laminations. A bio-based BOPE film can be made by sequential or simultaneous orientation processes well-known in the art using a core layer (B) of substantially bio-based high or medium density ethylene homopolymer. Blends of high, medium, low, or linear low density bio-based ethylene homopolymer or copolymers may include this core layer as desired. Skin layers including bio-based high density polyethylene, medium density polyethylene, low density polyethylene, linear low density polyethylene, or blends thereof, may be coextruded with the core layer (B) on one or both sides of said core layer (B). In the case of two coextruded skin layers on each side of said core layer, the respective skin layers may be of the same formulation or different formulations. The skin layers may be formulated to achieve desired properties such as heat sealability, printability, metallizing, etc. as desired. The skin layers and core layer may be formulated with suitable additives such as antiblocks, migratory fatty amides, anti-statics, waxes, etc. for controlling coeffecient of friction properties, static generation, or moisture barrier, as described previously.

### Test Methods

The various properties described herein were measured by the following methods:

Oxygen transmission rate of the film was measured by using a Mocon Oxtran 2/20 unit substantially in accordance with ASTM D3985.In general, the preferred value was an average value equal to or less than 31.0 cc/m²/day with a maximum of 46.5 cc/m²/day. Moisture transmission rate of the film was measured by using a Mocon Permatran 3/31 unit measured substantially in accordance with ASTM F1249. In general, the preferred value was an average value equal to or less than 0.31 g/m²/day with a maximum of 0.70 g/m²/day.

Optical density was measured using a Tobias Associates model TBX transmission densitometer. Optical density is defined as the amount of light reflected from the test specimen under specific conditions. Optical density is reported in terms of a logarithmic conversion. For example, a density of 0.00 indicates that 100% of the light falling on the sample is being reflected. A density of 1.00 indicates that 10% of the light is being reflected; 2.00 is equivalent to 1%, etc.

Wetting tension of the surfaces of interest was measured substantially in accordance with ASTM D2578-67. In general, the preferred value was an average value equal to or more than 40 dyne/cm with a minimum of 36 dyne/cm.

Radiocarbon/biomass content pMC was measured substantially in accordance with ASTM D6866-10 “Renewable Carbon Testing” procedure. Analytical methods used to measure ¹⁴C content of respective bio-based and petroleum-based polyolefin materials and articles made include Liquid Scintillation Counting (LSC), Accelerator Mass Spectrometry (AMS), and Isotope Ratio Mass Spectroscopy (IRMS) techniques. Bio-based content is calculated by deriving a ratio of the amount of radiocarbon in the article of interest to that of the modern reference standard. This ratio is reported as a percentage of contemporary radiocarbon (pMC or percent modern carbon) and correlates directly to the amount of biomass material present in the article.

Heat seal strength is measured by using a Sentinel sealer model 12 ASL at 30 psi (206.8 Pa), 0.5 second dwell time, with heated flat upper seal jaw Teflon coated, and unheated lower seal jaw, rubber with glass cloth-covered. The film is heat-sealed sealant-side to sealant- side at the desired seal temperature range and increments in the Sentinel sealer (e.g. 180-290° F. at 10° F. (82.2° C. at 5.56° C.) increments) and then the respective seal strengths are measured using an Instron model 4201 tensile tester. The heat-sealed samples are cut into 1-inch (25 mm) wide strips, the two unsealed tails are placed in the upper and lower Instron clamps and the sealed tail supported at a 90° angle to the two unsealed tails for a 90° T-peel test. The peak and average seal strength is recorded. The preferred values for acceptable heat seal strength is 400 g/25 mm or greater at 250° F. (121° C.) seal temperature.

Hot tack strength is measured by using a Lako Tool hot tack/sealer model SL10 at 30 psi (206.8 Pa), 0.5 second dwell time, with heated flat lower seal jaw Teflon coated, and unheated upper seal jaw and with delay set to 0 seconds. The film sample is cut into a strip 13 inches (330 mm) long by 1 inch (25 mm) wide and fitted into the Lako SL10 film holder. The film is then heat-sealed sealant-side to sealant- side at the desired seal temperature range and increments in the Lako sealer (e.g. 180-290° F. at 10° F. (82.2° C. at 5.56° C.) increments) and then the respective hot tack strengths are measured by the Lako SL10 sealer automatically. The peak hot tack strength is recorded. The preferred values for acceptable hot tack is 150 g/25 mm or greater at 250° F. (121° C.) seal temperature.

Heat seal and hot tack seal initiation temperature (SIT) is measured by using the above methods (A) and (B) using the Sentinel 12 ASL or Lako Tool SL10 hot tack sealer. Heat seal initiation temperature is the lowest temperature at which minimum 200 g/25 mm seal strength is achieved. Hot tack initiation temperature is the lowest temperature at which minimum 150 g/25 mm hot tack is achieved. Initiation temperatures of 200° F. (93.3° C.). or less are preferred.

Transparency of the film was measured by measuring haze of a single sheet of film substantially in accordance with ASTM D1003.

Metal adhesion was measured by heat sealing on a SENTINAL Sealer model 12 ASL at 220° F. (104.4° C.) seal temperature, 15 second dwell, and 15 psi (103.42 kPa) seal jaw pressure, a piece of 1-mil (25 μm) thick Ethylene Acrylic Acid polymer film (EAA) to the metallized surface of a single sheet of metallized film and measuring the 180° peel strength of the metal from the substrate substantially in accordance with AIMCAL (Association of Industrial Metallizers, Coaters, and Laminators) test procedure TP-105-92. The test procedure and a kit of materials can be obtained from AIMCAL's website www.aimcal.com. The Metal Adhesion Test Kit is designed to permit testing using TP-105-92. The test kit contains 2 rolls of 3M™ tape #610, 2 rolls of EAA film and an AIMCAL Metallizing Technical Reference Manual. The test kit contains enough material to do at least 100 tests as described in the Technical Reference Manual, (TP-105-92). The test procedure used in testing the samples used in the examples of this application is described in AIMCAL Metallizing Technical Reference (Third Edition, © 2001). In general, preferred values of metal adhesion ranged from about 50 g/in (50 g/25 mm) minimum or higher.

Metal appearance was rated qualitatively using a ranking system of 1-4, with 1 equating to a very matte or high density of defects (e.g. die lines, gels, etc) metallized film appearance and 4 equating to a very shiny, glossy, reflective, defect-free metallized film appearance. 8½″×11″ cut sheet samples of the metallized films were observed on a white background under office flourescent lighting, and ranked in order of metal shininess. The preferred rating is a “4” and with “2” as minimum acceptability.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed as new and desired to be protected by Letters Patent of the United States is:

1. A laminate bio-based polyolefin film comprising:
a bio-based polyolefin resin-containing layer having a radiocarbon content of at least 53 pMC.

2. The laminate film of claim 1, wherein bio-based polyolefin film is biaxially oriented.

3. The laminate film of claim 1, wherein the bio-based polyolefin resin-containing layer comprises a crystalline isotactic propylene homopolymer.

4. The laminate film of claim 1, wherein the bio-based polyolefin resin-containing layer is co-extruded with an additional layer comprising a bio-based polyolefin.

5. The laminate film of claim 4, wherein the additional layer comprises a bio-based propylene homopolymer, ethylene homopolymer, propylene-ethylene copolymer, propylene-ethylene-butene copolymer, or ethylene-butene copolymer.

6. The laminate film of claim 1, wherein the bio-based polyolefin resin-containing layer comprises a polyolefin derived from a plant sugar.

7. The laminate film of claim 1, wherein a surface of the laminate bio-based polyolefin film is discharge-treated.

8. The laminate film of claim 7, further comprising a metal layer on the discharge-treated surface.

9. The laminate film of claim 8, wherein the metal is aluminum.

10. The laminate film of claim 8, wherein the metal layer has an optical density of 1.5-5.0.

11. The laminate film of claim 1, wherein the bio-based polyolefin resin-containing layer comprises a bio-based ethylene homopolymer.

12. The laminate film of claim 1, wherein the bio-based polyolefin resin-containing layer comprises a high density ethylene homopolymer.

13. The laminate film of claim 11, wherein the bio-based polyolefin resin-containing layer is co-extruded with an additional layer comprising a bio-based polyolefin.

14. The laminate film of claim 13, wherein the additional layer comprises a bio-based propylene homopolymer, ethylene homopolymer, propylene-ethylene copolymer, propylene-ethylene-butene copolymer, or ethylene-butene copolymer.

15. The laminate film of claim 1, wherein the bio-based polyolefin resin-containing layer has a radiocarbon content of at least 97 pMC.

16. The laminate film of claim 1, wherein the bio-based polyolefin resin-containing layer has a radiocarbon content of about 107.5 pMC.

17. A lamination comprising:
a first biaxially oriented bio-based polyolefin film having a radiocarbon content of at least 53 pMC;
a second biaxially oriented bio-based polyolefin film having a radiocarbon content of at least 53 pMC; and
an adhesive that laminates the first biaxially oriented bio-based polyolefin film to the second biaxially oriented bio-based polyolefin film.

18. The lamination of claim 17, further comprising a vapor-deposited aluminum layer on a side of the first biaxially oriented bio-based polyolefin film.

19. The lamination of claim 17, further comprising inks exhibiting a graphic content on a side of the second biaxially oriented bio-based polyolefin film.

20. The lamination of claim 17, wherein the first biaxially oriented bio-based polyolefin film comprises a propylene homopolymer of at least 53 pMC.

21. The lamination of claim 17, wherein the second biaxially oriented bio-based polyolefin film comprises a propylene homopolymer of at least 53 pMC.

22. The lamination of claim 17, wherein the first biaxially oriented bio-based polyolefin film comprises an ethylene homopolymer of at least 53 pMC.

23. The lamination of claim 17, wherein the second biaxially oriented bio-based polyolefin film comprises an ethylene homopolymer of at least 53 pMC.

24. The lamination of claim 17, wherein the adhesive comprises a bio-based low density polyethylene of at least 53 pMC.

25. A method of making a laminate film comprising:
co-extruding a first bio-based polyolefin resin-containing layer having a radiocarbon content of at least 53 pMC; and
a second bio-based polyolefin resin-containing layer having a radiocarbon content of at least 53 pMC.

26. The method of claim 25, further comprising biaxially orienting the laminate film.

27. A method of forming a lamination comprising:
extruding a first bio-based polyolefin film having a radiocarbon content of at least 53 pMC;
extruding a second bio-based polyolefin film having a radiocarbon content of at least 53 pMC;
biaxially orienting the first bio-based polyolefin film and the second bio-based polyolefin film; and
laminating the first biaxially oriented bio-based polyolefin film to the second biaxially oriented bio-based polyolefin film using an adhesive.

28. The method of claim 27, further comprising vapor-depositing an aluminum layer on a side of the first biaxially oriented bio-based polyolefin film.

29. The method of claim 27, further comprising applying inks exhibiting a graphic content on a side of the second biaxially oriented bio-based polyolefin film.

30. The method of claim 27, wherein the adhesive comprises a bio-based low density polyethylene of at least 53 pMC.
